(19) United States
(12) Patent Application Publication
(10) Pub. No.: US 2025/0050858 A1
(43) Pub. Date: Feb. 13, 2025

(54) ELECTRIC BRAKE HAVING PARKING SWITCH MODULE

(71) Applicant: HL MANDO CORPORATION, Gyeonggi-do (KR)

(72) Inventor: Woochul LIM, Gyeonggi-do (KR)

(21) Appl. No.: 18/534,738

(22) Filed: Dec. 11, 2023

(30) Foreign Application Priority Data
Aug. 11, 2023 (KR) 10-2023-0105721

(51) Int. Cl. B60T 13/74; F16D 65/18; F16D 65/22

(52) U.S. Cl. CPC B60T 13/746; F16D 65/18; F16D 65/22; F16D 2121/24; F16D 2125/48; F16D 2125/52; F16D 2127/06

(57) ABSTRACT

An electric brake of a caliper type according to an embodiment may include: a caliper device including a caliper body and a pair of brake pads installed in the caliper body; a driver including a housing forming a space therein, an electric motor configured to generate a driving force, and a transfer device configured to move the pair of brake pads with a driving force; and a parking switch module configured to limit an operation of the transfer device.

### CROSS-REFERENCE TO RELATED APPLICATION(S)

This application is based on and claims priority under 35 U.S.C. § 119 to Korean Patent Application No. 10-2023-0105721, filed on Aug. 11, 2023, in the Korean Intellectual Property Office, the disclosure of which is incorporated by reference herein in its entirety.

### BACKGROUND

### 1. Field

The disclosure relates to an electric brake having a parking switch module.

### 2. Description of the Related Art

A brake system is an apparatus that decelerates and stops a vehicle in motion and maintains the vehicle in a stopped state. The brake system includes a parking brake that decelerates and stops a vehicle in motion and maintains the vehicle in a stopped state.

The parking brake maintains the stopped state of the wheels by pulling the parking cable by the control of a lever located to one side of the driver seat inside the vehicle to provide a braking force to the wheels connected to the parking cable, and removes the braking force provided to the wheels by releasing the lever to release the parking cable.

Because the parking brake operates only by a driver's intention, the driver should control the lever whenever parking or starting driving, which has caused the driver's great inconvenience in use. For this reason, an Electric Parking Brake (EPB) system for automatically operating the parking brake by the motor according to the operation state of the vehicle has been developed.

Brake systems are classified into a positive brake system and a negative brake system. The positive brake system is a brake system that causes a contact of the brake disc by supplying pressure to the brake disc ordinarily being in a non-contact state in order to stop the vehicle or reduce the speed of the vehicle. In contrast, the negative brake system is a brake system that separates the brake disc by supplying pressure to the brake disc ordinarily being in a contact state in order to move the vehicle.

The negative brake system operates the brake by releasing pressure through a driver's control in a normal state. However, in emergency situations, such as a situation in which the vehicle stalls during driving, a situation in which the engine stops abnormally, a situation in which a problem occurs in the electrical system, a situation in which a problem occurs in the hydraulic or pneumatic system, etc., the negative brake system applies a braking force by the parking brake by automatically releasing pressure supplied to the parking brake.

### SUMMARY

It is an embodiment of the disclosure to provide a caliper type electric brake having a parking switch module

It is an embodiment of the disclosure to provide a drum type electric brake having a parking switch module.

Additional aspects of the disclosure will be set forth in part in the description which follows and, in part, will be obvious from the description, or may be learned by practice of the disclosure.

In accordance with an aspect of the disclosure, an electric brake of a caliper type may include: a caliper device including a caliper body and a pair of brake pads installed in the caliper body: a driver including a housing forming a space therein, an electric motor configured to generate a driving force, and a transfer device configured to move the pair of brake pads with a driving force; and a parking switch module configured to limit an operation of the transfer device.

The transfer device may include: an input gear coupled to a rotating shaft of the electric motor; a transfer gear spaced from the input gear; a power transfer belt configured to interlock a rotation of the input gear with the transfer gear; and an outputter configured to move the pair of brake pads by receiving a driving force from the transfer gear.

The transfer gear may include: a cylindrical portion including an outer circumference on which a pinion gear is formed; and a flange portion including an edge in which a latch groove is formed at regular intervals.

The parking switch module may include: a pawl pin installed in the housing;

a pawl rotatably coupled to the pawl pin; a driving pin configured to rotate the pawl by pushing one end of the pawl; and a driving valve configured to move the driving pin.

The parking switch module may further include a unlock pin configured to rotate the pawl by pushing another end of the pawl.

A rear end of the unlock pin may be configured to be exposed to outside of the housing by penetrating the housing.

The parking switch module may further include a torsion spring positioned between the pawl and the pawl pin and configured to provide a restoring force to the pawl.

The parking switch module may further include a spring installed on a top end of the unlock pin.

One end of the pawl may be configured to be coupled to the latch groove according to a movement of the driving pin by the driving valve after the transfer gear rotates in a forward direction.

While one end of the pawl does not depart from the latch groove upon a parking release, the one end of the pawl may be configured to rotate by the unlock pin pushing another end of the pawl and depart from the latch groove.

According to an aspect of the disclosure, an electric brake of a drum type may include: a drum brake portion installed in a wheel of a vehicle; a driver including a housing forming a space therein, an electric motor configured to generate a driving force, and a gear set configured to rotate by a driving force; and a parking switch module accommodated inside the driver and configured to limit a rotation of the gear set.

The gear set may include: an input gear coupled to a rotating shaft of the electric motor; and a transfer gear configured to rotate by receiving a driving force from the input gear.

A pinion gear may be formed on an outer circumference of the transfer gear, and a latch groove may be formed at regular intervals in a front surface of the transfer gear along an edge of the front surface.

The parking switch module may include: a pawl pin installed in the housing; a pawl rotatably coupled to the pawl pin; a driving pin configured to rotate the pawl by pushing one end of the pawl; and a driving valve configured to move the driving pin.

The parking switch module may further include an unlock pin configured to rotate the pawl by pushing another end of the pawl.

The parking switch module may further include a torsion spring positioned between the pawl and the pawl pin and configured to provide a restoring force to the pawl.

The electric motor may be accommodated in a motor housing protruding from one side of the housing, and the driving valve may be accommodated in a valve housing protruding from another side of the housing.

The driver may further include a driving shaft extending to inside of the drum brake portion, and the driving shaft may be positioned coaxially with the transfer gear by penetrating a center of the transfer gear, and configured to interlock with a rotation of the transfer gear.

In a parking mode, one end of the pawl may be coupled to the latch groove by rotating by the driving pin after the transfer gear rotates in the forward direction.

While one end of the pawl does not depart from the latch groove upon a parking release, the one end of the pawl may be configured to rotate by the unlock pin and depart from the latch groove, and then, the transfer gear may be configured to rotate in a backward direction.

### BRIEF DESCRIPTION OF THE DRAWINGS

These and/or other aspects of the disclosure will become apparent and more readily appreciated from the following description of the embodiments, taken in conjunction with the accompanying drawings of which: FIG. 1 is a perspective view for describing a caliper type electric brake according to an embodiment of the disclosure;

FIG. 2 is an enlarged perspective view of an area indicated by A in FIG. 1;

FIG. 3 is a view for describing an operation of a parking switch module of the electric brake shown in FIG. 1 in a parking mode;

FIG. 4 is a view for describing conversion from the parking mode to a release mode in FIG. 3;

FIG. 5 is a perspective view for describing a drum type electric brake according to an embodiment of the disclosure;

FIG. 6 is a front view of the electric brake shown in FIG. 5;

FIG. 7 is a rear view of the electric brake shown in FIG. 5; and

FIG. 8 is a view for describing a parking switch module of the electric brake shown in FIG. 5.

### DETAILED DESCRIPTION

Hereinafter, embodiments of the disclosure will be described in detail with reference to the accompanying drawings. The following embodiments are provided to transfer the concepts of the disclosure to one of ordinary skill in the technical art to which the disclosure belongs. However, the disclosure is not limited to these embodiments, and may be embodied in another form. In the drawings, parts that are irrelevant to the descriptions may be not shown in order to clarify the disclosure, and also, for easy understanding, the widths, lengths, thicknesses, etc. of components may be more or less exaggeratedly shown. Like reference numerals refer to like components throughout the specification.

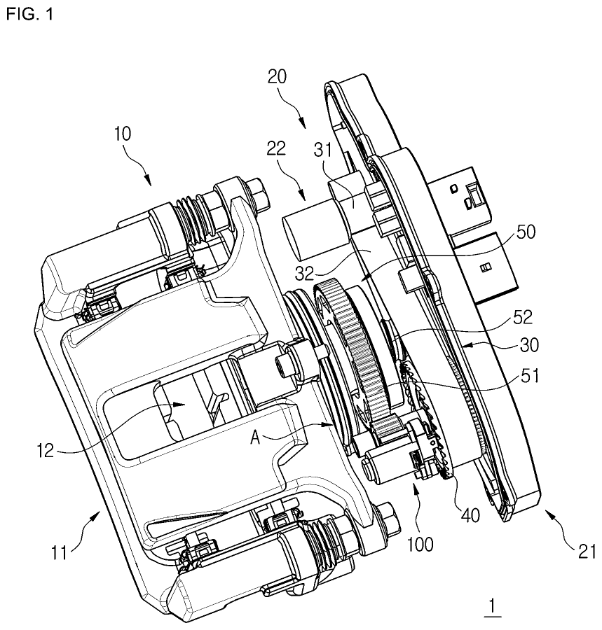

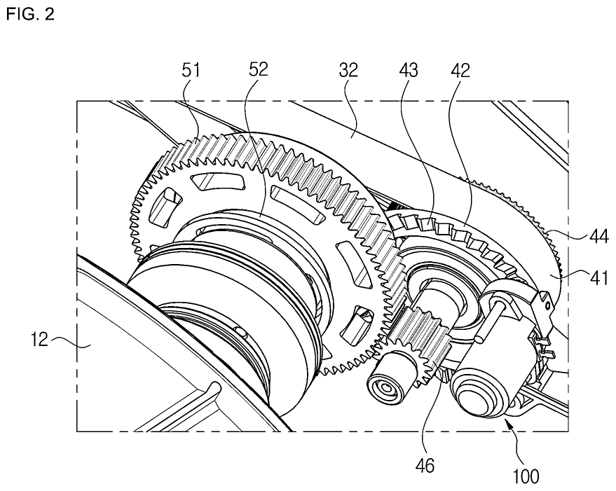

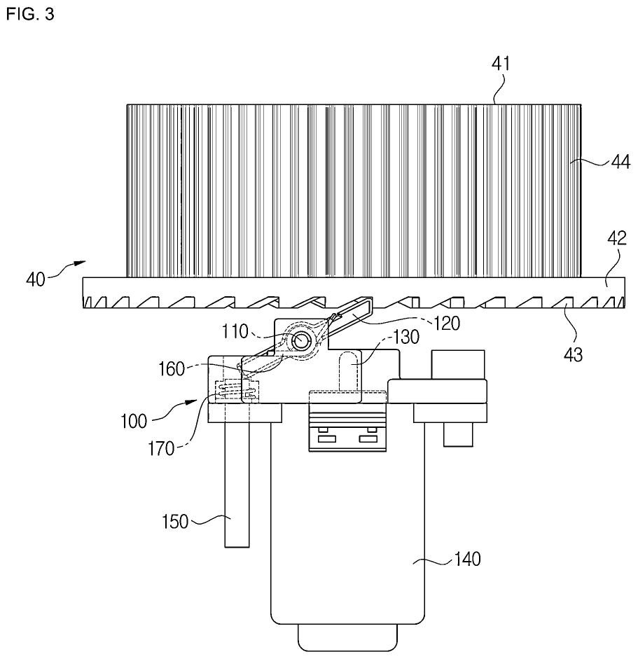

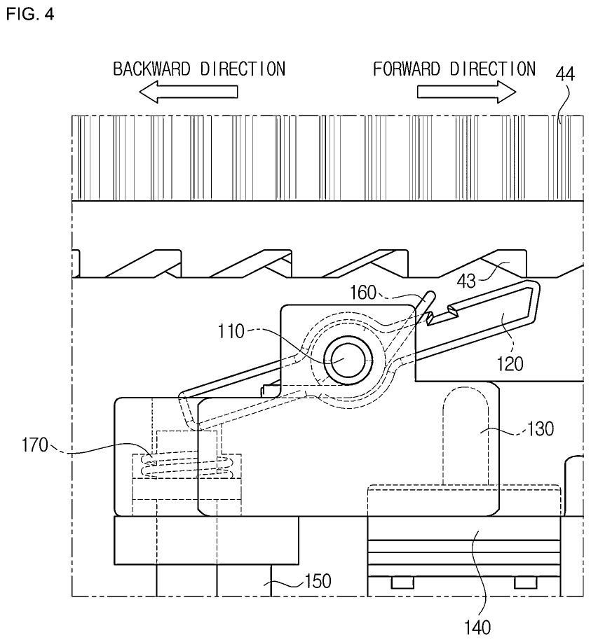

FIG. 1 is a perspective view for describing a caliper type electric brake (Caliper EMB) 1 according to an embodiment of the disclosure. FIG. 2 is an enlarged perspective view of an area indicated by A in FIG. 1. FIG. 3 is a view for describing an operation of a parking switch module 100 of the electronic brake 1 shown in FIG. 1 in a parking mode. FIG. 4 is a view for describing conversion from the parking mode to a release mode in FIG. 3.

Referring to FIGS. 1 to 4, the caliper type electric brake 1 will be described. The caliper type electric brake 1 may be an electromechanical brake installed on a brake disc, and correspond to a normal brake operating with electricity, not a parking brake.

The caliper type electric brake 1 may include: a caliper device 10 including a caliper body 11 and a pair of brake pads 12 installed in the caliper body 11; a driver 20 including a housing 21 forming a space therein, an electric motor 22 for generating a driving force, and a transfer device 30 for moving the brake pads 12 with a driving force; and a parking switch module 100 configured to limit an operation of the transfer device 30.

As the market share of electric vehicles and autonomous vehicles increases, needs for development of EMB (electromechanical brake) which operates with electricity without hydraulic pressure have increased, and the EMB may provide normal braking and parking brake functions.

When a motor for releasing parking fails to be driven for an unknown cause after parking, the braking force may not be released and it may be impossible to tow the vehicle. In these cases, it may be difficult to bring the vehicle back to its normal state, and against this, a mechanical backup plan for releasing parking under the concept of fail safe is required.

The electric brake 1 may provide, as the parking switch module 100, a parking brake force release apparatus capable of releasing, when electronic equipment of EMB fails, a parking brake force by a mechanical method from outside.

The transfer device 30 may include an input gear 31 coupled to a rotating shaft of the electric motor 22, a transfer gear 40 spaced from the input gear 31, a power transfer belt 32 for interlocking a rotation of the input gear 31 with the transfer gear 40, and an outputter 50 configured to move the brake pads 12 by receiving a driving force from the transfer gear 40.

The outputter 50 may include an output gear 51 that rotates by engaging with the transfer gear 40, and a pressing shaft 52 configured to push the brake pads 12 by moving by a rotation of the output gear 51. The output gear 51 may rotate by engaging with a shaft gear 46 that rotates by interlocking with the transfer gear 40.

The transfer gear 40 may include a cylindrical portion 41 having an outer circumference on which a pinion gear 44 is formed, and a flange portion 42 having an edge in which a latch groove 43 is formed at regular intervals. The latch groove 43 may be a rachet allowing a rotation only in one direction, wherein one side of the latch groove 43 may have a gentle slope and another side of the latch groove 43 may be in a shape of a projection.

The parking switch module 100 may include a pawl pin 110 installed in the housing 21, a pawl 120 rotatably coupled to the pawl pin 110, a driving pin 130 configured to rotate the pawl 120 by pushing one end of the pawl 120, and a driving valve 140 configured to move the driving pin 130. The pawl pin 110 may function as a rotating axis of the pawl 120.

The driving pin 130 may be coupled to and integrated into the driving valve 140 to move forward or backward from the driving valve 140. The driving valve 140 may be, for example, a solenoid valve.

The parking switch module 100 may further include a torsion spring 160 positioned between the pawl 120 and the pawl pin 110 to provide a restoring force to the pawl 120. Accordingly, in a non-parking state, that is, in a state in which the driving pin 130 does not push one end of the pawl 120, one end of the pawl 120 may not be inserted into the latch groove 43.

The parking switch module 100 may further include a unlock pin 150 configured to rotate the pawl 120 by pushing another end of the pawl 120. The unlock pin 150 may rotate the pawl 120 in an opposite direction of a direction in which the driving pin 130 rotates the pawl 120. A rear end of the unlock pin 150 may penetrate the housing 21 and be exposed to outside of the housing 21. Because a portion of the unlock pin 150 is exposed to the outside of the housing 21, it may be easy to operate the unlock pin 150 upon occurrence of a failure.

The parking switch module 100 may further include a spring 170 installed on a top end of the unlock pin 150. The spring 170 may be a compression spring, such as a coil spring, a wave spring, and the like.

An operating mechanism (upon application) of the parking switch module 100 will be described below. One end of the pawl 120 may be coupled to the latch groove 43 when the driving valve 140 moves the driving pin 130 after the transfer gear 40 rotates in a forward direction.

More specifically, upon turning-on of the electric motor 22, the transfer gear 40 may rotate in the forward direction to generate a parking brake force. In contrast, upon turning-off of the electric motor 22, the transfer gear 40 may rotate in the backward direction to release the parking brake force. Upon turning-on of the driving valve 140, the driving pin 130 may move forward, and accordingly, the pawl 120 may rotate to be coupled to the latch groove 43. Upon turning-off of the driving valve 140, the driving pin 130 may move backward, and due to the coupling of the pawl 120 to the latch groove 43, the transfer gear 40 may be prevented from rotating in the backward direction, thereby maintaining the parking brake force.

An operating mechanism (upon release) of the parking switch module 100 will be described below. By turning on the electric motor 22, the transfer gear 40 may rotate by a preset distance in the forward direction. Accordingly, the pawl 120 may be decoupled from the latch groove 43 and rotate to an original position by the restoring force of the torsion spring 160. Then, the transfer gear 40 may rotate in the backward direction to release the parking brake force.

When one end of the pawl 120 does not depart from the latch groove 43 while parking is released, the pawl 120 may rotate by the unlock pin 150 pushing the other end of the pawl 120, and thereby, the one end of the pawl 120 may depart from the latch groove 43. That is, when parking is not released for a cause, such as a failure of the electric motor 22, a failure of the torsion spring 160, etc., parking may be released by operating the unlock pin 150 outside the housing 21.

The unlock pin 150 may correspond to fail safe for releasing a parking brake force by a mechanical method upon a failure of electronic equipment. The unlock pin 150 may be controllable from the outside and decouple the pawl 120 from the latch groove (Ratchet) 43 by pressing the pawl 120 to rotate the pawl 120, and the torsion spring 160 may be compressed by an external force upon operation while fixing the unlock pin 150 to an original position.

When the unlock pin 150 is pressed from the outside of the housing 21, the unlock pin 150 may compress the torsion spring 160 and move toward the other end of the pawl 120 to press the other end of the pawl 120. In this case, the pawl 120 may rotate on the pawl pin 110 as the rotating axis to release a contact with the latch groove 43, thereby releasing the parking brake force.

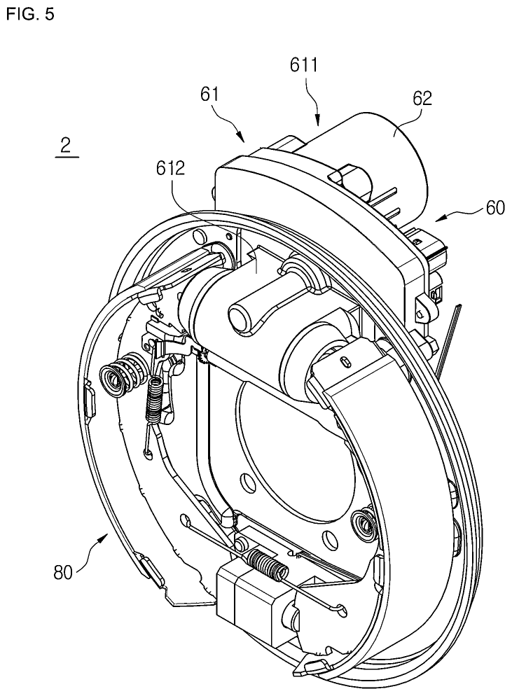

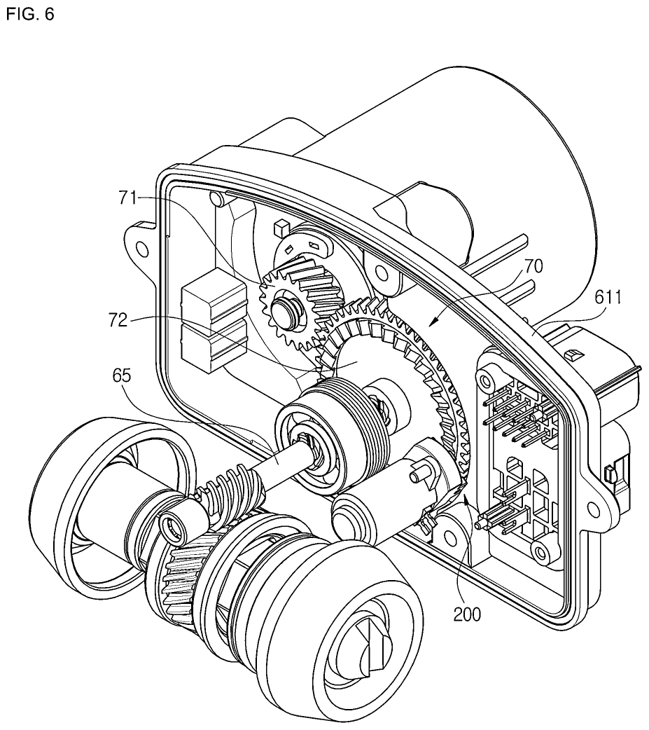

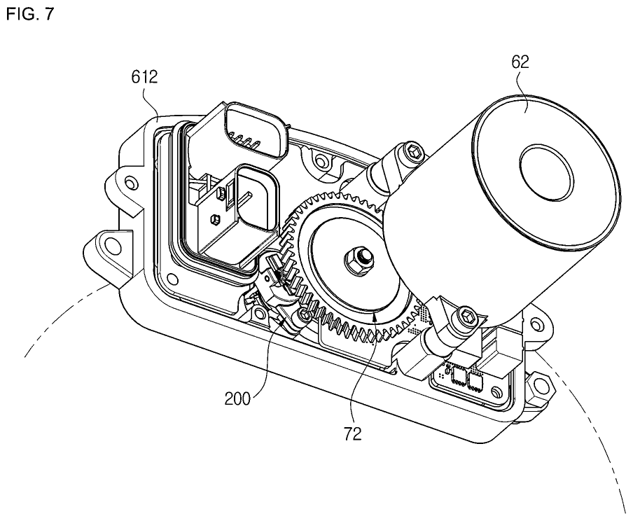

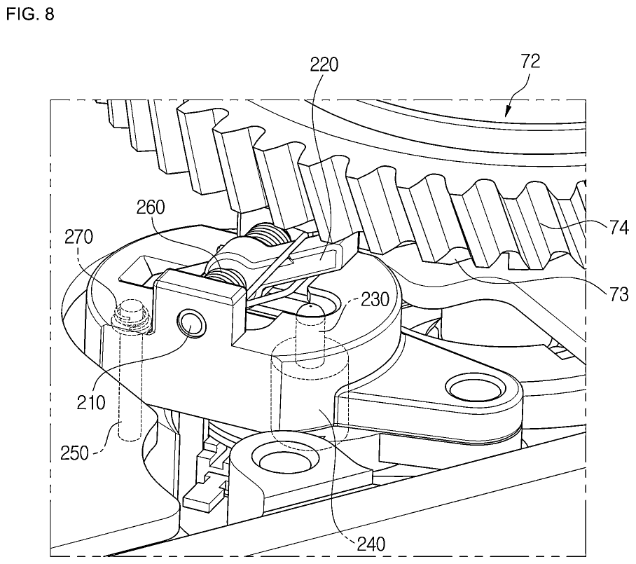

FIG. 5 is a perspective view for describing an operation state of a drum type electric brake 2 according to an embodiment of the disclosure. FIG. 6 is a front view of the electric brake 2 shown in FIG. 5. FIG. 7 is a rear view of the electric brake 2 shown in FIG. 5. FIG. 8 is a view for describing a driving shaft 65 of the electric brake 2 shown in FIG. 5. Descriptions about the same content as that described in the above embodiments will be omitted.

The drum type electric brake (Drum EMB) 2, which is an electromechanical brake installed in a drum, may be used commonly as a parking brake and operate with electricity.

The drum type electronic brake 2 may include: a drum brake portion 80 installed in a wheel of a vehicle; a driver 60 including a housing 61 forming a space therein, an electric motor 62 for generating a driving force, and a gear set 70 that rotates by a driving force; and a parking switch module 200 accommodated inside the driver 60 and configured to limit a rotation of the gear set 70.

The gear set 70 may include an input gear 71 coupled to a rotating shaft of the electric motor 62, and a transfer gear 72 that rotates by receiving a driving force from the input gear 71.

On an outer circumference of the transfer gear 72, a pinion gear 74 may be formed, and in a front surface of the transfer gear 72, a latch groove 73 may be formed at regular intervals along an edge of the front surface.

The parking switch module 200 may include a pawl pin 210 installed in the housing 61, a pawl 220 rotatably coupled to the pawl pin 210, a driving pin 230 configured to rotate the pawl 220 by pushing one end of the pawl 220, and a driving valve 240 configured to move the driving pin 230. The pawl pin 210 may function as a rotating axis of the pawl 220.

The electric motor 62 may be accommodated in a motor housing 611 protruding from one side of the housing 61, and the driving valve 240 may be accommodated in a valve housing 612 protruding from another side of the housing 61.

The parking switch module 200 may further include a unlock pin 250 configured to rotate the pawl 220 by pushing another end of the pawl 220.

The parking switch module 200 may further include a torsion spring 260 positioned between the pawl 220 and the pawl pin 210 to provide a restoring force to the pawl 220.

The driver 60 may further include a driving shaft 65 extending to inside of the drum brake portion 80, and the driving shaft 65 may be positioned coaxially with the transfer gear 72 by penetrating a center of the transfer gear 72, and configured to interlock with a rotation of the transfer gear 72.

In a parking mode, one end of the pawl 220 may be coupled to the latch groove 73 by rotating by the driving pin 230 after the transfer gear 72 rotates in the forward direction.

When the one end of the pawl 220 does not depart from the latch groove 73 while parking is released, the one end of the pawl 220 may rotate by the unlock pin 250 pushing another end of the pawl 220 and depart from the latch groove 73, and then, the transfer gear 72 may rotate in the backward direction.

According to an embodiment, fail safe against a malfunction of the parking function of the electric brake may be provided.

The electric brake according to an embodiment may release a braking force by causing the unlock pin included in the parking switch module to rotate the pawl caught by the parking gear.

The electric brake according to an embodiment may control the pawl more accurately by providing two pins capable of pressing both sides of the pawl.

So far, although the disclosure has been described by the limited embodiments and drawings, the disclosure is not limited to these, and various corrections and modifications can be made by one of ordinary skill in the technical art to which the disclosure belongs within the technical concepts of the disclosure and equivalents of the appended claims.

What is claimed is:

1. An electric brake of a caliper type comprising:
a caliper device including a caliper body and a pair of brake pads installed in the caliper body;
a driver including a housing forming a space therein, an electric motor configured to generate a driving force, and a transfer device configured to move the pair of brake pads with a driving force; and
a parking switch module configured to limit an operation of the transfer device.

2. The electric brake of claim 1, wherein the transfer device includes:
an input gear coupled to a rotating shaft of the electric motor;
a transfer gear spaced from the input gear;
a power transfer belt configured to interlock a rotation of the input gear with the transfer gear; and
an outputter configured to move the pair of brake pads by receiving a driving force from the transfer gear.

3. The electric brake of claim 2, wherein the transfer gear includes:
a cylindrical portion including an outer circumference on which a pinion gear is formed; and
a flange portion including an edge in which a latch groove is formed at regular intervals.

4. The electric brake of claim 3, wherein the parking switch module includes:
a pawl pin installed in the housing;
a pawl rotatably coupled to the pawl pin;
a driving pin configured to rotate the pawl by pushing one end of the pawl; and
a driving valve configured to move the driving pin.

5. The electric brake of claim 4, wherein the parking switch module further includes a unlock pin configured to rotate the pawl by pushing another end of the pawl.

6. The electric brake of claim 5, wherein a rear end of the unlock pin is configured to be exposed to outside of the housing by penetrating the housing.

7. The electric brake of claim 4, wherein the parking switch module further includes a torsion spring positioned between the pawl and the pawl pin and configured to provide a restoring force to the pawl.

8. The electric brake of claim 5, wherein the parking switch module further includes a spring installed on a top end of the unlock pin.

9. The electric brake of claim 5, wherein one end of the pawl is configured to be coupled to the latch groove according to a movement of the driving pin by the driving valve after the transfer gear rotates in a forward direction.

10. The electric brake of claim 5, wherein, while one end of the pawl does not depart from the latch groove upon a parking release, the one end of the pawl is configured to rotate by the unlock pin pushing another end of the pawl and depart from the latch groove.

11. An electric brake of a drum type comprising:
a drum brake portion installed in a wheel of a vehicle;
a driver including a housing forming a space therein, an electric motor configured to generate a driving force, and a gear set configured to rotate by a driving force; and
a parking switch module accommodated inside the driver and configured to limit a rotation of the gear set.

12. The electric brake of claim 11, wherein the gear set includes:
an input gear coupled to a rotating shaft of the electric motor; and
a transfer gear configured to rotate by receiving a driving force from the input gear.

13. The electric brake of claim 12, wherein
a pinion gear is formed on an outer circumference of the transfer gear, and
a latch groove is formed at regular intervals in a front surface of the transfer gear along an edge of the front surface.

14. The electric brake of claim 13, wherein the parking switch module includes:
a pawl pin installed in the housing;
a pawl rotatably coupled to the pawl pin;
a driving pin configured to rotate the pawl by pushing one end of the pawl; and
a driving valve configured to move the driving pin.

15. The electric brake of claim 14, wherein the parking switch module further includes an unlock pin configured to rotate the pawl by pushing another end of the pawl.

16. The electric brake of claim 14, wherein the parking switch module further includes a torsion spring positioned between the pawl and the pawl pin and configured to provide a restoring force to the pawl.

17. The electric brake of claim 14, wherein
the electric motor is accommodated in a motor housing protruding from one side of the housing, and
the driving valve is accommodated in a valve housing protruding from another side of the housing.

18. The electric brake of claim 14, wherein
the driver further includes a driving shaft extending to inside of the drum brake portion, and
the driving shaft is positioned coaxially with the transfer gear by penetrating a center of the transfer gear, and configured to interlock with a rotation of the transfer gear.

19. The electric brake of claim 15, wherein in a parking mode, one end of the pawl is coupled to the latch groove by rotating by the driving pin after the transfer gear rotates in the forward direction.

20. The electric brake of claim 15, wherein, while one end of the pawl does not depart from the latch groove upon a parking release, the one end of the pawl is configured to rotate by the unlock pin and depart from the latch groove, and then, the transfer gear is configured to rotate in a backward direction.
